(19) United States
(12) Patent Application Publication
(10) Pub. No.: US 2020/0376499 A1
(43) Pub. Date: Dec. 3, 2020

(54) Dielectrophoresis Separation Object Sorting

(71) Applicant: Delee Corp., Laredo, TX (US)

(72) Inventors: Liza Velarde, Laredo, TX (US); Alejandro Abarca-Blanco, Laredo, TX (US); Juan Felipe YEE, Laredo, TX (US)

(73) Assignee: Delee Corp., Laredo, TX (US)

(21) Appl. No.: 16/481,447

(22) PCT Filed: Jan. 26, 2018
(86) PCT No.: PCT/US2018/015519

§ 371 Date: Jul. 26, 2019

Related U.S. Application Data
(60) Provisional application No. 62/450,958, filed on Jan. 26, 2017.

(51) Int. Cl. B03C 5/02

(52) U.S. Cl. CPC B03C 5/026; B03C 2201/26

(57) ABSTRACT

Techniques and devices for sorting objects using dielectrophoresis separation. A device can include a non-linear dielectrophoresis separation channel for use in sorting object in a flow of a volume of a liquid solution using dielectrophoresis separation. Techniques can include controlling operation of a device configured to sort objects using dielectrophoresis separation based on characteristics of the sorting of objects by the device using dielectrophoresis separation.

### BRIEF DESCRIPTION OF THE DRAWINGS

FIG. 1 depicts a diagram of an example of a system for sorting objects using dielectrophoresis separation.

FIG. 2 depicts a flowchart of an example of sorting objects in a volume of liquid solution through dielectrophoresis separation using a non-linear dielectrophoresis separation channel.

FIG. 3 depicts a diagram of a Clausius-Mossotti factor of objects within a medium as a function of a radian frequency of an applied non-uniform electric field.

FIG. 4 depicts a diagram of a top view of an example dielectrophoresis separation channel used to sort objects in a medium through dielectrophoresis separation.

FIG. 5 depicts a cross-sectional view of an electrode configuration used to produce a non-uniform electrode field for purposes of sorting objects through dielectrophoresis separation.

FIG. 6 depicts a diagram of a top view of a cross-section of an example circular helix shaped dielectrophoresis separation channel used to sort objects in a medium through dielectrophoresis separation.

FIG. 7 depicts a diagram of a top view of a cross-section of an example square helix shaped dielectrophoresis separation channel used to sort objects in a medium through dielectrophoresis separation.

FIG. 8 depicts a diagram of an example of a dielectrophoresis cell sorting microfluidic device control system.

FIG. 9 depicts a flowchart of an example of a method for controlling operation of a device configured to sort objects through dielectrophoresis separation based on characteristics of sorting objects through dielectrophoresis separation.

### DETAILED DESCRIPTION

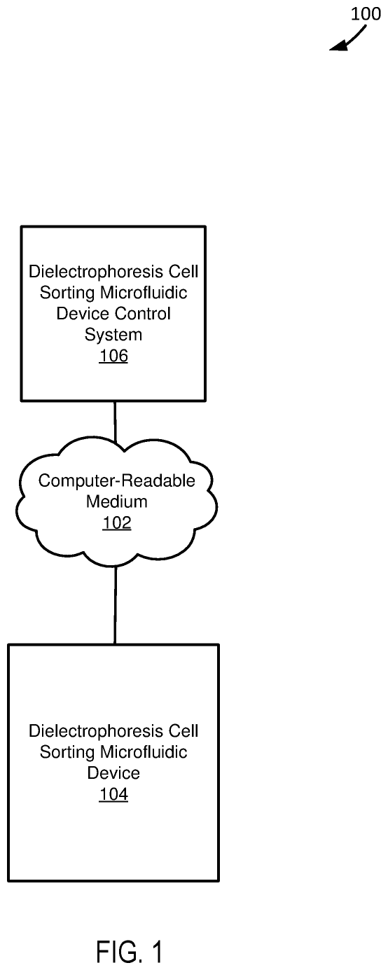

FIG. 1 depicts a diagram 100 of an example of a system for sorting objects using dielectrophoresis separation. The system of the example of FIG. 1 includes a computer-readable medium 102, a dielectrophoresis cell sorting microfluidic device 104, and a dielectrophoresis cell sorting microfluidic device control system 106.

The computer-readable medium 102 and other computer readable mediums discussed in this paper are intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 and other computer readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. That is, the engine includes hardware. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example system shown in FIG. 1, the dielectrophoresis cell sorting microfluidic device 104 is intended to represent a device that functions to sort cells using dielectrophoresis separation. The dielectrophoresis cell sorting microfluidic device 104 can sort cells using dielectrophoresis separation of cells of different types within a volume of liquid solution. For example, the dielectrophoresis cell sorting microfluidic device 104 can sort cells within a volume of blood using dielectrophoresis separation. Further in the example, the dielectrophoresis cell sorting microfluidic device 104 can sort white blood cells from circulatory tumor cells within a volume of blood. In another example, the dielectrophoresis cell sorting microfluidic device 104 can sort leukemia cells from white blood cells within a volume of blood.

In sorting cells using dielectrophoresis separation, the dielectrophoresis cell sorting microfluidic device 104 functions to sort cells using varying dielectrophoretic forces applied to the cells as part of dielectrophoresis separation. Varying dielectrophoretic forces applied to different cells within a volume of liquid solution can vary by applying a non-uniform electric field to the volume of liquid solution. A non-uniform electric filed can be applied to a volume liquid solution by varying either or both the magnitude of an electric field and direction of an electric field applied to different portions of the volume of liquid solution. For example, a non-uniform electric field can be applied to a volume of liquid solution by applying an electric field at a first magnitude to a first portion of the volume of liquid and an electric field at a second magnitude different from the first magnitude to a second portion of the volume of liquid. In applying varying dielectrophoretic forces to a volume of liquid, the dielectrophoresis cell sorting microfluidic device 104 is configured to apply a non-uniform electric field to a volume of liquid solution as part of sorting cells within the liquid using dielectrophoresis separation.

Equation 1, shown below, illustrates an example of a dielectrophoretic force as a function of a non-uniform electric field.

F=2πεₘR³Re[CM(ω)·∇E²(r,ω)], Equation 1

In Equation 1, F represents a dielectrophoretic force applied to a particular object in response to application of a non-uniform electric field E. For purposes of discussion of Equation 1 the word “object” is used but in various implementations an object can include a cell within a volume of liquid solution. R represents a radius of an object and εₘ represents a permittivity of an object or a medium containing the object. F is directly proportional to CM which represents a Clausius-Mossotti (hereinafter referred to as “CM”) factor. The sign of the CM factor can vary between positive and negative, resulting in either a corresponding negative dielectrophoretic force applied to an object or a positive dielectrophoretic force applied to an object. A negative dielectrophoretic force applied to an object can cause the object to be displaced towards electric field minima, while a positive dielectrophoretic force applied to an object can cause the object to be displaced towards electric field maxima.

Application of either a negative or positive dielectrophoretic force to an object can be used to sort objects using dielectrophoresis separation. Specifically, positive dielectrophoretic forces can be applied to objects of a first type and either or both no dielectrophoretic forces or negative dielectrophoretic forces can be applied to objects of a second type to cause the objects of the first type to separate from the objects of the second type, subsequently sorting the objects using dielectrophoresis separation. For example, positive dielectrophoretic forces can be applied to circulating tumor cells within a sample of blood and simultaneously negative dielectrophoretic forces can be applied to white blood cells within the sample of blood cells to cause the tumor cells to segregate away from the white blood cells through dielectrophoresis separation. Further in the example, the positive dielectrophoretic forces can push the tumor cells out of the sample of blood and into a buffer.

As whether a positive or negative dielectrophoretic force applied to an object depends on a CM factor of the object at any given time, a CM factor of an object in response to a non-uniform electric field at any given time can be controlled to regulate whether a positive or negative dielectrophoretic force is applied to the object. For example, a CM factor of a white blood cell can be adjusted to apply either a positive dielectrophoretic force to the cell, a negative dielectrophoretic force to the cell, or no dielectrophoretic force to the cell. The CM factor of an object in a medium is a function, in part, of a radian frequency of an applied non-uniform electric field to the object at a given time, a permittivity of the medium, and a conductivity of the medium. As a result, a CM factor of an object can be adjusted by varying one or a combination of a radian frequency of an applied non-uniform electric field, a permittivity of a medium surrounding the object, and conductivity of a medium surrounding the object.

In being adjustable, a CM factor of an object can be controlled to ensure that either a positive dielectrophoretic force, a negative dielectrophoretic force, or no dielectrophoretic force is applied to an object. For example, if a white blood cell has a negative CM factor within a specific radian frequency range, then a non-uniform electric field applied to the white blood cell can be limited to the specific radian frequency range to ensure that the white blood cell has a negative CM factor when exposed to the non-uniform electric field. Further in the example, by limiting the non-uniform electrical field to the specific radian frequency range, a negative dielectrophoretic force can be continuously applied to the white blood cell when it is exposed to the non-uniform electric field.

CM factors in response to application of a non-uniform electric field can be controlled for purposes of sorting objects through dielectrophoresis separation. For example, CM factors of cells within a volume of blood exposed to a non-uniform electric field can be controlled to cause tumor cells to either migrate away from white blood cells, out of the volume of blood, or towards an edge of the volume of blood, as part of dielectrophoresis separation. Further in the example, the CM factors of the cells within the volume of blood can be controlled to cause application of a negative dielectrophoretic force to the white blood cells when the volume of blood is exposed to the non-uniform electric field and cause application of a positive dielectrophoretic force to the tumor cells when the volume of blood is exposed to the non-uniform electric field. In controlling CM factors of objects for controlling sorting of the objects through dielectrophoresis separation in response to application of a non-uniform electric field, one or a combination of a radian frequency of the applied non-uniform electric field, a permittivity of a medium surrounding the objects, and conductivity of a medium surrounding the objects can be controlled. For example, a non-uniform electric field applied to a volume of blood can be kept within a specific radian frequency range to cause white blood cells to experience negative dielectrophoretic forces and tumor cells to experience positive dielectrophoretic forces when the volume of blood is exposed to the electric field for purposes of sorting the cells using dielectrophoresis separation.

The dielectrophoresis cell sorting microfluidic device 104 incudes at least one dielectrophoresis separation channel configured to contain a volume of liquid solution for purposes sorting objects within the volume of liquid solution using dielectrophoresis separation. Specifically, a volume of liquid solution contained within a dielectrophoresis separation channel of the dielectrophoresis cell sorting microfluidic device 104 can be used in application of a non-uniform electric field to the contained volume of liquid as part performing dielectrophoresis separation. For example, a dielectrophoresis separation channel can contain a volume of blood and be used to sort cells within the volume of blood through application of a non-uniform electric field to the contained volume of blood as part of dielectrophoresis separation.

A dielectrophoresis separation channel of the dielectrophoresis cell sorting microfluidic device 104 functions to contain a flow of a volume of liquid solution to apply a non-uniform electric field to cells within the volume of liquid solution for purposes of sorting the cells using dielectrophoresis separation. For example, as a volume of liquid solution contained within a dielectrophoresis separation channel flows through the channel, a non-uniform electric field varying in either or both direction and magnitude can be applied to different cells within the volume of liquid solution, thereby achieving application of a non-uniform electric field to the volume of liquid solution for purposes of sorting the different cells using dielectrophoresis separation. A flow of a volume of liquid solution within a dielectrophoresis separation channel of the dielectrophoresis cell sorting microfluidic device 104 can be created and maintained using an applicable mechanism for displacing a volume of liquid. For example, a flow of a volume of liquid solution in a dielectrophoresis separation channel of the dielectrophoresis cell sorting microfluidic device 104 can be created and maintained using a pump. In another example, a flow of a volume of liquid solution in a dielectrophoresis separation channel of the dielectrophoresis cell sorting microfluidic device 104 can be created and maintained as a result of capillary motion.

In a specific implementation, a dielectrophoresis separation channel included as part of the dielectrophoresis cell sorting microfluidic device 104 is of an applicable size and shape to allow for the dielectrophoresis cell sorting microfluidic device 104 to sort objects on a microfluidic scale using dielectrophoresis separation. For example, at least a portion of a dielectrophoresis separation channel included as part of the dielectrophoresis cell sorting microfluidic device 104 can have a channel height of four hundred μm. A dielectrophoresis separation channel included as part of the dielectrophoresis cell sorting microfluidic device 104 can have a channel height on the μm scale with varying channel depths. For example, a dielectrophoresis separation channel included as part of the dielectrophoresis cell sorting microfluidic device 104 can have a channel height of four hundred μm with varying channel depths. In having varying channel depths, a dielectrophoresis separation channel included as part of the dielectrophoresis cell sorting microfluidic device 104 can cause focusing of a flow of a contained volume of a liquid solution within the dielectrophoresis separation channel A greater throughput of an amount of sorted volume of liquid can be achieved from flow focusing caused by varying channel depths within a dielectrophoresis separation channel.

In a specific implementation, a dielectrophoresis separation channel included as part of the dielectrophoresis cell sorting microfluidic device 104 can be fabricated using 3D printing. In fabricating a dielectrophoresis separation channel included as part of the dielectrophoresis cell sorting microfluidic device 104 using 3D printing, the dielectrophoresis separation channel can have a varying depth, e.g. be fabricated with arbitrary and differing depth levels. As discussed previously, dielectrophoresis channels with varying depth levels can focus a flow of a contained volume of liquid solution, potentially leading to greater processing throughput. A dielectrophoresis separation channel included as part of the dielectrophoresis cell sorting microfluidic device 104 can be fabricated using an applicable 3D printing mechanism. For example, a dielectrophoresis separation channel included as part of the dielectrophoresis cell sorting microfluidic device 104 can be fabricated using extrusion deposition, granular material binding, lamination, and photopolymerization.

In a specific implementation, the dielectrophoresis cell sorting microfluidic device 104 includes a non-linear dielectrophoresis separation channel A non-linear dielectrophoresis separation channel included as part of the dielectrophoresis cell sorting microfluidic device 104 can be of a size on a μm scale to aid in performing dielectrophoresis separation on a microfluidic scale. For example, a non-linear dielectrophoresis separation channel can have a height of five hundred μm. Additionally, a non-linear dielectrophoresis separation channel included as part of the dielectrophoresis cell sorting microfluidic device 104 can include a plurality of repeated curves. For example, a non-linear dielectrophoresis separation channel can be serpentine shaped. In being non-linear, a non-linear dielectrophoresis separation channel included as part of the dielectrophoresis cell sorting microfluidic device 104 can increase throughput of the dielectrophoresis cell sorting microfluidic device 104 in sorting objects within a contained volume of liquid solution through dielectrophoresis separation. For example, a non-linear dielectrophoresis separation channel included as part of the dielectrophoresis cell sorting microfluidic device 104 can be used to focus a flow of a volume of liquid solution contained within the dielectrophoresis separation channel In an example of observed results, using one or a plurality of non-linear dielectrophoresis separation channels, the dielectrophoresis cell sorting microfluidic device 104 can sort cells in eight cubic centimeters of blood in an hour or less using dielectrophoresis separation.

In a specific implementation, the dielectrophoresis cell sorting microfluidic device 104 includes a helix shaped dielectrophoresis separation channel. A helix shaped dielectrophoresis separation channel included as part of the dielectrophoresis cell sorting microfluidic device 104 can be of a size on a μm scale to aid in performing dielectrophoresis separation on a microfluidic scale. For example, a helix shaped dielectrophoresis separation channel of the dielectrophoresis cell sorting microfluidic device 104 can have a channel width of two hundred μm. A helix shaped dielectrophoresis separation channel can have either a circular shaped cross-section or a square shaped cross-section. For example, a helix shaped dielectrophoresis separation channel can be a channel with a square footprint formed in a shape of a helix. A square helix shaped dielectrophoresis separation channel of the dielectrophoresis cell sorting microfluidic device 104 can dissipate heat effectively. This is beneficial in increasing throughput of the dielectrophoresis cell sorting microfluidic device 104 in sorting cells using dielectrophoresis separation, as the faster the flow of a contained volume of liquid solution, the greater the amount of generated heat, potentially leading to destruction of objects, e.g. cells within the volume of liquid solution.

A dielectrophoresis separation channel of the dielectrophoresis cell sorting microfluidic device 104 can contain flows of two different contained volumes of liquid for purposes of sorting objects using dielectrophoresis separation. For example, a dielectrophoresis separation channel of the dielectrophoresis cell sorting microfluidic device 104 can contain both a flow of a sample of blood and a buffer for purposes of sorting cells from the blood using dielectrophoresis separation. Two different contained volumes of liquid solution can flow in parallel, or otherwise adjacent to each other, in a dielectrophoresis separation channel included as part of the dielectrophoresis cell sorting microfluidic device 104 for purposes of sorting objects in the liquid solutions. For example, a sample of blood can flow within a dielectrophoresis separation channel of the dielectrophoresis cell sorting microfluidic device 104 next to a buffer in the channel. Further in the example, the sample of blood can be exposed to a non-uniform electric field as it flows through the channel to force a specific type of cells within the blood into the sample, for purposes of sorting cells using dielectrophoresis separation.

In a specific implementation, a dielectrophoresis separation channel of the dielectrophoresis cell sorting microfluidic device 104 is sterilizable. In being sterilizable, a dielectrophoresis separation channel of the dielectrophoresis cell sorting microfluidic device 104 can be of an applicable size and fabricated from an applicable material to allow the channel to be sterilized. For example, a dielectrophoresis separation channel of the dielectrophoresis cell sorting microfluidic device 104 can be fabricated from a polymer that is capable of being heated to 121° C. for purposes of sterilizing the channel In another example, a dielectrophoresis channel of the dielectrophoresis cell sorting microfluidic device 104 can be fabricated from a material that is resistant to or otherwise does not degrade in response to introduction of chemical agents used to sterilize the channel.

The dielectrophoresis cell sorting microfluidic device 104 includes electrodes for use in applying a non-uniform electric field to a contained volume of liquid solution for purposes of sorting objects within the volume of liquid using dielectrophoresis separation. Electrodes can be positioned in the dielectrophoresis cell sorting microfluidic device 104 and be of an applicable shape and size to apply a non-uniform electric field to a volume of liquid solution contained within a channel of the dielectrophoresis cell sorting microfluidic device 104. Additionally, electrodes can be positioned with respect to one of a plurality of dielectrophoresis separation channels within the dielectrophoresis cell sorting microfluidic device 104 to cause application of a non-uniform electric field to a volume of liquid solution contained within the dielectrophoresis separation channels. For example, electrodes can be positioned underneath specific portions of a dielectrophoresis separation channel of the dielectrophoresis cell sorting microfluidic device 104 such that other portions of the dielectrophoresis separation channel lack an underlying electrode. Further in the example, as only portions of the dielectrophoresis channel have underlying electrodes, a non-uniform electric field is applied to a volume of liquid solution as it flows through the dielectrophoresis channel.

In a specific implementation, the dielectrophoresis cell sorting microfluidic device 104 includes electrodes encasing at least a portion of a dielectrophoresis separation channel. For example, when the dielectrophoresis cell sorting microfluidic device 104 includes a non-linear dielectrophoresis separation channel, then an electrode can surround the channel at the linear portions of the channel In another example, when the dielectrophoresis cell sorting microfluidic device 104 includes a helix shaped dielectrophoresis separation channel a first electrode can surround an outer surface of the helix shaped dielectrophoresis separation channel along an outer radius of the channel, while a second electrode can surround an inner surface of the helix shaped dielectrophoresis separation channel along an inner radius of the channel.

In a specific implementation, the dielectrophoresis cell sorting microfluidic device 104 has a dielectrophoresis separation channel with inlets for introducing flows of volumes of liquids for purposes of sorting objects using dielectrophoresis separation. For example, a dielectrophoresis separation channel of the dielectrophoresis cell sorting microfluidic device 104 can include a sample inlet used to introduce a flow of a volume of liquid solution containing objects to be sorting through dielectrophoresis separation into a dielectrophoresis separation channel In another example, a dielectrophoresis separation channel of the dielectrophoresis cell sorting microfluidic device 104 can include a buffer inlet used to introduce a flow of a volume of liquid buffer configured to receive sorted objects using dielectrophoresis separation.

In being used to apply a non-uniform electric field, power can be provided to electrodes of the dielectrophoresis cell sorting microfluidic device 104. Either or both an alternating or direct current can be applied to electrodes of the dielectrophoresis cell sorting microfluidic device 104 to cause application of a non-uniform electric field to a contained volume of liquid solution for purposes of sorting object in the solution using dielectrophoresis separation. Power can be provided to electrodes of the dielectrophoresis cell sorting microfluidic device 104 using either or both a mobile power source included as part of the dielectrophoresis cell sorting microfluidic device 104 and a coupling to a stationary power source. For example, the dielectrophoresis cell sorting microfluidic device 104 can include a coupling to a power grid outlet which can provide AC power to electrodes of the dielectrophoresis cell sorting microfluidic device 104.

In a specific implementation, power provided to electrodes of the dielectrophoresis cell sorting microfluidic device 104 is managed based on characteristics of sorting objects through dielectrophoresis separation using the device. Characteristics of sorting objects through dielectrophoresis separation include applicable characteristics of sorting objects using dielectrophoresis separation. Example characteristics of sorting objects through dielectrophoresis separation include characteristics of objects in a contained medium to be sorted, characteristics of mediums containing objects to be sorted, characteristics of additions to a volume of liquid solution, characteristics of target objects to be sorted from a contained medium, and a time window in which to sort objects in a volume of liquid solution. For example, if a specific type of cell is in a contained volume of blood, then characteristics of sorting objects through dielectrophoresis separation can include a range of radian frequencies of an applied electric field at which the specific type of cell experiences a positive dielectrophoretic force. In another example, if specific tumor cells are to be detected in a contained volume of blood using dielectrophoresis separation then characteristic of sorting objects through dielectrophoresis separation can include a range of radian frequencies of an applied electric field at which the specific tumor cells experience a positive dielectrophoretic force.

In a specific implementation, power provided to electrodes of the dielectrophoresis cell sorting microfluidic device 104 is managed to generate a non-uniform electric field at a specific radian frequency or range of radian frequencies. For example, a specific alternating current can be provided to electrodes of the dielectrophoresis cell sorting microfluidic device 104 to cause the electrodes to generate a non-uniform electric field within a specific range of radian frequencies. Power provided to electrodes of the dielectrophoresis cell sorting microfluidic device 104 based on a specific radian frequency or range of radian frequencies can be managed as part of managing power to the electrodes based on characteristics of sorting objects through dielectrophoresis separation. For example, if a target cell to be separated from a volume of blood experiences a positive dielectrophoretic force, corresponding to a positive Clausius-Mossotti factor, in response to a non-uniform electric field with radian frequencies within a specific range of frequencies, then power to the electrodes can be managed to cause the electrodes to produce a non-uniform electric field with a radian frequency within the specific range. Further in the example, if tumor cells within the volume of blood experience a positive dielectrophoretic force in response to a non-uniform electric field with frequencies in the specific range of frequencies, then power to the electrodes can be managed to cause the electrodes to produce the non-uniform electric field at the range of frequencies to cause separation of the tumor cells from the volume of blood through dielectrophoresis separation.

In a specific implementation, power provided to electrodes of the dielectrophoresis cell sorting microfluidic device 104 can be managed based on characteristics of two objects within a medium to be sorted using dielectrophoresis separation. Power provided to electrodes of the dielectrophoresis cell sorting microfluidic device 104 based on characteristics of two objects within a medium can be managed as part of managing power to the electrodes based on characteristics of sorting objects through dielectrophoresis separation. In managing power based on characteristics of two objects within a medium, power can be provided to electrodes of the dielectrophoresis cell sorting microfluidic device 104 to cause one object to experience a positive dielectrophoretic force and the other object to experience either a negative dielectrophoretic force or no dielectrophoretic force. For example, power can be provided to electrodes of the dielectrophoresis cell sorting microfluidic device 104 to create a non-uniform electric field within a radian frequency range to cause a positive dielectrophoretic force to be applied to tumor cells in a volume of blood and a negative dielectrophoretic force or no dielectrophoretic force to white blood cells in the volume of blood.

In a specific implementation, the dielectrophoresis cell sorting microfluidic device 104 includes a dielectric layer between electrodes and a dielectrophoresis separation channel of the device 104. By including a dielectric layer between electrodes and a dielectrophoresis separation channel of the dielectrophoresis cell sorting microfluidic device 104, a non-uniform electric field created by the electrodes can be focused or otherwise limited to being present within the dielectrophoresis separation channel. For example, using a dielectric layer between electrodes positioned underneath a dielectrophoresis separation channel of the dielectrophoresis cell sorting microfluidic device 104, a portion of the non-uniform electric field extending out from the dielectrophoresis separation channel can be reduced along a specific direction, leading to a concentrated non-uniform electric field in the channel A dielectric layer between electrodes and a dielectrophoresis separation channel of the dielectrophoresis cell sorting microfluidic device 104 can be modified to change the properties of the dielectric layer. For example, a dielectric layer between electrodes and a dielectrophoresis separation channel of the dielectrophoresis cell sorting microfluidic device 104 can be integrated with or include carbon nanotubes to increase the conductivity of the dielectric layer.

In a specific implementation, the dielectrophoresis cell sorting microfluidic device 104 is configured to apply dielectrophoretic forces to cells within a contained volume of liquid solution while minimizing the number of cells killed by application of such forces. Specifically, the dielectrophoresis cell sorting microfluidic device 104 can be configured to apply dielectrophoretic forces to cells within a contained volume of liquid solution to effectively sort the cells using dielectrophoresis separation, while still keeping the cells alive. For example, the dielectrophoresis cell sorting microfluidic device 104 can capture cells within blood at a depletion rate of 0.003 or less. Depletion rate includes a total number of cells that are not captured or are killed out of a total number of cells to be sorted through dielectrophoresis separation. Further in the example, the dielectrophoresis cell sorting microfluidic device 104 can process eight cubic centimeters of blood within an hour or less at the depletion rate of 0.003 and a capture efficiency of 0.901 or greater. Capture efficiency refers to a number of cells out of a total number of cells within a contained volume of liquid solution that are captured using dielectrophoresis separation.

In a specific implementation, the dielectrophoresis cell sorting microfluidic device 104 is configured to sort objects within a medium through dielectrophoresis separation as part of a label-free approach to sorting the objects within the medium. In sorting objects within a medium through a label-free approach, the dielectrophoresis cell sorting microfluidic device 104 can sort the objects regardless of an expression of the objects. For example, the dielectrophoresis cell sorting microfluidic device 104 can sort cells within a medium agnostic to expressions of the cells.

In a specific implementation, the dielectrophoresis cell sorting microfluidic device 104 is configured to use dielectrophoresis separation to sort objects within a medium in which an additive has been added. For example, the dielectrophoresis cell sorting microfluidic device 104 can use dielectrophoresis separation to sort cells within a volume of blood in which ferromagnetic particles have been added. Further in the example, the dielectrophoresis cell sorting microfluidic device 104 can use dielectrophoresis separation to sort leukemia cells from a volume of blood with added ferromagnetic particles using the ferromagnetic particles. In sorting objects within a medium in which an additive has been added through dielectrophoresis separation, the dielectrophoresis cell sorting microfluidic device 104 can sort objects within the medium using the additive as part of a label approach.

In a specific implementation, the dielectrophoresis cell sorting microfluidic device 104 is portable. In being portable, the dielectrophoresis cell sorting microfluidic device 104 can be used to sort objects within a medium in the field. For example, the dielectrophoresis cell sorting microfluidic device 104 can be moved to a testing site in the field and used to detect whether specific bacteria are present in a person.

In a specific implementation, the applicable components of the dielectrophoresis cell sorting microfluidic device 104 are modular. For example, the dielectrophoresis cell sorting microfluidic device 104 can include one or a combination of a dielectrophoresis separation channel module, a power module, a sample introduction module, and a sample collection module. A dielectrophoresis separation channel module can include one or a plurality of dielectrophoresis separation channels and electrodes configured to create non-uniform electric fields within the one or a plurality of channels. A power module is configured to provide power used in creating a non-uniform electric field in dielectrophoresis separation channels. A sample introduction module is configured to introduce a sample containing objects within a medium to be sorted and a buffer used in collecting objects sorted using dielectrophoresis separation. A sample collection module is configured to collect a sample and a buffer including sorted objects from the sample. In being modular, the various modules of the dielectrophoresis cell sorting microfluidic device 104 can be removable. For example a dielectrophoresis separation channel module can be removed from the dielectrophoresis cell sorting microfluidic device 104 and sterilized.

Referring back to FIG. 1, the dielectrophoresis cell sorting microfluidic device control system 106 is intended to represent a system that functions to control operation of a device configured to sort objects in a medium using dielectrophoresis separation. The dielectrophoresis cell sorting microfluidic device control system 106 can control operation of an applicable device configured to sort objects in a medium using dielectrophoresis separation, such as the dielectrophoresis cell sorting microfluidic devices described in this paper. For example, the dielectrophoresis cell sorting microfluidic device control system 106 can control a device in operation to separate tumor cells from a volume of blood using dielectrophoresis separation. The dielectrophoresis cell sorting microfluidic device control system 106 can be implemented at or remote from an applicable device configured to sort objects in a medium using dielectrophoresis separation. For example, the dielectrophoresis cell sorting microfluidic device control system 106 can be implemented through hardware, e.g. a processor and memory, at an applicable device for sorting objects in a medium using dielectrophoresis separation.

In controlling operation of a device configured to sort objects in a medium using dielectrophoresis separation, the dielectrophoresis cell sorting microfluidic device control system 106 can control power provided to electrodes of the device. For example, the dielectrophoresis cell sorting microfluidic device control system 106 can regulate whether power is supplied to specific electrodes of an applicable device for sorting objects in a medium using dielectrophoresis separation. In another example, the dielectrophoresis cell sorting microfluidic device control system 106 can control an amount of power supplied to specific electrodes of an applicable device for sorting objects in a medium using dielectrophoresis separation. The dielectrophoresis cell sorting microfluidic device control system 106 can control power provided to electrodes of an applicable device for sorting objects in a medium using dielectrophoresis separation for purposes of the electrodes generating a non-uniform electric field to sort the objects in the medium.

In a specific implementation, the dielectrophoresis cell sorting microfluidic device control system 106 functions to control power provided to electrodes of a device configured to sort objects in a medium using dielectrophoresis separation according to characteristics of sorting object through dielectrophoresis separation using the device. In controlling power according to characteristics of sorting objects through dielectrophoresis separation, the dielectrophoresis cell sorting microfluidic device control system 106 can manage power based on characteristics of an object to be sorted from a medium using dielectrophoresis separation. Additionally, in controlling power according to characteristics of sorting objects through dielectrophoresis separation, the dielectrophoresis cell sorting microfluidic device control system 106 can manage power based on a volume of medium to process and a speed at which to process the medium using dielectrophoresis separation.

In a specific implementation, the dielectrophoresis cell sorting microfluidic device control system 106 functions to control power provided to electrodes of a device configured to sort objects in a medium using dielectrophoresis separation based on a specific radian frequency or range of radian frequencies of a non-uniform electric field created at the device. In controlling power based on a range of radian frequencies of a non-uniform electric field created for sorting objects through dielectrophoresis separation, the dielectrophoresis cell sorting microfluidic device control system 106 can control power based on characteristics of an object to be sorted using dielectrophoresis separation. For example, if a tumor cell to be sorted from a volume of blood experiences a positive dielectrophoretic force in response to a non-uniform electric field within a specific radian frequency range, then the dielectrophoresis cell sorting microfluidic device control system 106 can control power to electrodes to cause the electrodes to create a non-uniform electric field within the specific radian frequency range.

In a specific implementation, the dielectrophoresis cell sorting microfluidic device control system 106 functions to control power provided to electrode of a device configured to sort objects in a medium using dielectrophoresis separation based on characteristics of two objects within the medium to be sorted. The dielectrophoresis cell sorting microfluidic device control system 106 can manage power based on characteristics of two objects within a medium as part of managing power to the electrodes based on characteristics of sorting objects through dielectrophoresis separation. The dielectrophoresis cell sorting microfluidic device control system 106 can control power provided to electrodes of a device to cause one object to experience a positive dielectrophoretic force in response to a non-uniform electric field and the other object to experience either a negative dielectrophoretic force or no dielectrophoretic force in response to the non-uniform electric field. For example, the dielectrophoresis cell sorting microfluidic device control system 106 can control power to a device for creating a non-uniform electric field within a radian frequency range to cause a positive dielectrophoretic force to be applied to tumor cells in a volume of blood and a negative dielectrophoretic force or no dielectrophoretic force to white blood cells in the volume of blood.

In a specific implementation, the dielectrophoresis cell sorting microfluidic device control system 106 functions to determine characteristics of sorting objects through dielectrophoresis separation. Determined characteristics of sorting object through dielectrophoresis separation can be used by the dielectrophoresis cell sorting microfluidic device control system 106 to control operation of an applicable device for sorting objects in a medium through dielectrophoresis separation. For example, if it is determined a specific type of cell is being targeted for sorting from a volume of blood, then the dielectrophoresis cell sorting microfluidic device control system 106 can control power to a device for sorting objects using dielectrophoresis separation to cause the device to sort the specific type of cell from the blood. Further in the example, the dielectrophoresis cell sorting microfluidic device control system 106 can control power to the device to cause the device to create a non-uniform electric field within a range of radian frequencies to cause application of positive dielectrophoretic forces on the specific cells in response to the non-uniform electric field.

In a specific implementation, the dielectrophoresis cell sorting microfluidic device control system 106 functions to determine characteristics of sorting objects through dielectrophoresis separation based on input from an applicable source. For example, the dielectrophoresis cell sorting microfluidic device control system 106 can determine characteristics of sorting objects based on input received from an operator of an applicable device for sorting objects through dielectrophoresis separation. Further in the example, the dielectrophoresis cell sorting microfluidic device control system 106 can determine an identification of a specific type of cell to be sorted from a volume of blood based on input received from the operator.

In an example of operation of the example system shown in FIG. 1, a flow of a volume of blood is contained within a non-linear dielectrophoresis separation channel of the dielectrophoresis cell sorting microfluidic device 104. In the example of operation of the example system shown in FIG. 1, a flow of a volume of a liquid buffer is contained within the non-linear dielectrophoresis separation channel adjacent to the flow of the volume of blood. Further, in the example of operation of the example system shown in FIG. 1, the dielectrophoresis cell sorting microfluidic device control system 106 determines characteristics of sorting objects in the blood through dielectrophoresis separation. In the example of operation of the example system shown in FIG. 1, the dielectrophoresis cell sorting microfluidic device control system 106 provides power to electrodes of the dielectrophoresis cell sorting microfluidic device 104 based on the determined characteristics of sorting objects in the blood through dielectrophoresis separation. Additionally, in the example of operation of the example system shown in FIG. 1, the electrodes of the dielectrophoresis cell sorting microfluidic device 104 use the provided power to generate a non-uniform electric field at the dielectrophoresis cell sorting microfluidic device 104 based on the characteristics of sorting objects in the blood through dielectrophoresis separation. In the example of operation of the example system shown in FIG. 1, cells of a specific type within the blood migrated from the flow of the volume of blood into the flow of the volume of the liquid buffer within the non-linear dielectrophoresis channel in response to exposure to the non-uniform electric field generated by the electrodes at the dielectrophoresis cell sorting microfluidic device 104.

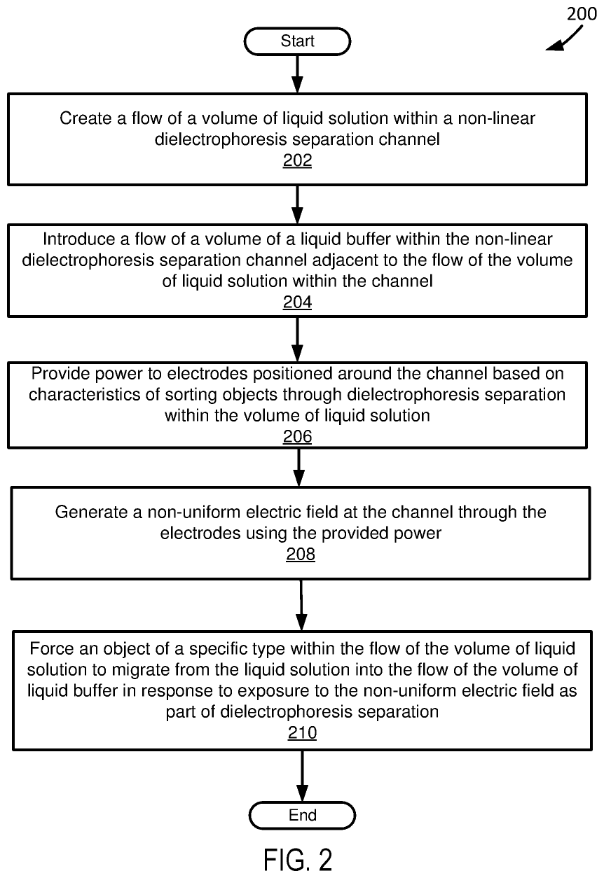

FIG. 2 depicts a flowchart 200 of an example of sorting objects in a volume of liquid solution through dielectrophoresis separation using a non-linear dielectrophoresis separation channel. The flowchart 200 begins at module 202, where a flow of a volume of liquid solution is created within a non-linear dielectrophoresis separation channel. A non-linear dielectrophoresis separation channel can be part of an applicable device for sorting cells using dielectrophoresis separation, such as the dielectrophoresis cell sorting microfluidic devices described in this paper. A non-linear dielectrophoresis separation channel in which a flow of a volume of liquid solution is created can be of an applicable non-linear shape. For example, a non-linear dielectrophoresis separation channel in which a flow of a volume of liquid solution is created can be serpentine or helix shaped. An applicable mechanism for displacing a volume of liquid can be used to create a flow of a volume of liquid solution in a non-linear dielectrophoresis separation channel. For example, a flow of a volume of liquid solution in a non-linear dielectrophoresis separation channel can be created using a pump or a capillary motion within the channel A non-linear dielectrophoresis separation channel can be or have portions that are sized on the μm scale, thereby the channel functions as a microfluidic channel.

The flowchart 200 continues to module 204, where a flow of a volume of liquid buffer is introduced within the non-linear dielectrophoresis separation channel adjacent to the flow of the volume of liquid solution within the channel. An applicable mechanism for displacing a volume of liquid can be used to create a flow of a volume of liquid buffer in the non-linear dielectrophoresis separation channel. For example, a flow of a volume of liquid buffer in the non-linear dielectrophoresis separation channel can be created using a pump or a capillary motion within the channel A liquid buffer can include an applicable liquid for receiving objects that are sorted out of the flow the volume of liquid solution through dielectrophoresis separation.

The flowchart 200 continues to module 206, where power is provided to electrodes positioned around the channel based on characteristics of sorting objects within the volume of liquid solution contained within the channel through dielectrophoresis separation. An applicable system for managing operation of a dielectrophoresis cell sorting microfluidic device, such as the dielectrophoresis cell sorting microfluidic device control systems described in this paper, can provide power to electrodes positioned around the channel based on characteristics of sorting objects within the volume of liquid solution contained within the channel through dielectrophoresis separation. Characteristics of sorting objects within the volume of liquid solution contained within the channel through dielectrophoresis separation can include characteristics of specific objects and types of objects to be sorted from within the volume of liquid solution. For example, if tumor cells are a target object to be sorted from the volume of liquid then a power to cause the electrodes to provide a non-uniform electric field at a radian frequency to apply a positive dielectrophoretic force on the tumor cells can be provided to the electrodes.

The flowchart 200 continues to module 208, where a non-uniform electric field is generated at the channel through the electrodes using the provided power. In generating a non-uniform electric field at the channel through the electrodes using the provided power, the flow of the volume of liquid solution and the flow of the volume liquid buffer within the non-linear dielectrophoresis separation channel can be exposed to the non-uniform electric field. The flow of the volume of liquid solution and the flow of the volume of liquid buffer can be exposed to the non-uniform electric field to perform dielectrophoresis separation on objects contained within the volume of liquid solution.

The flowchart 200 continues to module 210, where an object of a specific type within the flow of the volume of liquid solution is forced to migrate from the liquid solution into the flow of the volume of liquid buffer in response to exposure to the non-uniform electric field as part of dielectrophoresis separation. Specifically, as the flow of the volume of liquid solution is exposed to the non-uniform electric field, an object of a specific type experiences a dielectrophoretic force causing the object to migrate out of the flow of the volume of liquid solution and into the flow of the volume of liquid buffer. For example, tumor cells within a volume of blood can migrate out of the blood into a liquid buffer in response to dielectrophoretic forces generated from exposure of the volume of blood to a non-uniform electric field.

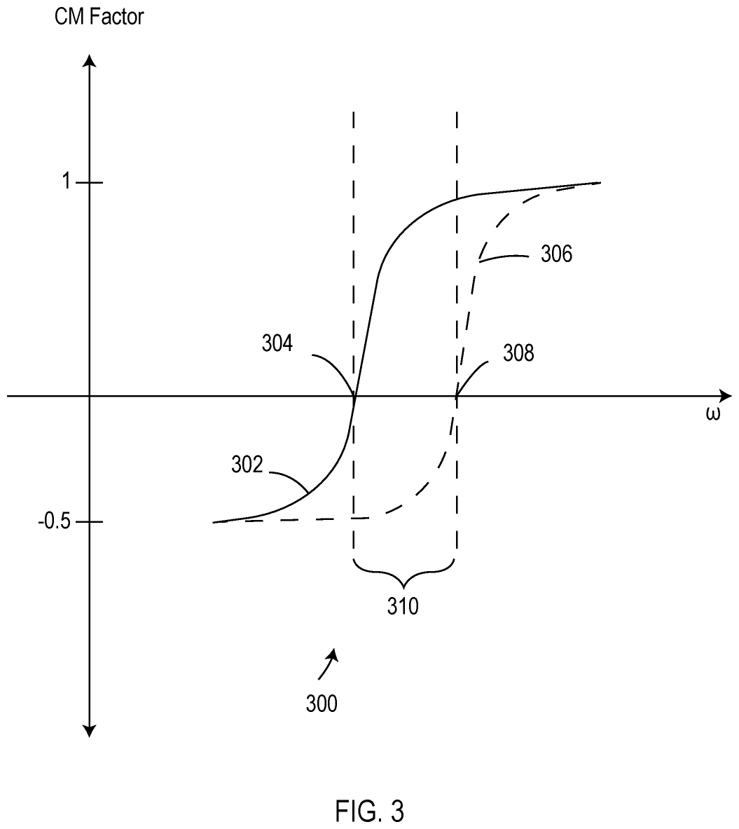

FIG. 3 depicts a diagram 300 of a CM factor of objects within a medium as a function of a radian frequency of an applied non-uniform electric field. Based on a CM factor, a radian frequency or range of radian frequencies can be selected for an applied non-uniform electric field in sorting objects within a medium using dielectrophoresis separation. For example, a range of radian frequencies of a non-uniform electric field can be selected and applied to a medium containing objects at the range of radian frequencies to cause application of positive dielectrophoretic forces to one type of object within a medium and negative dielectrophoretic forces to another type of object within the medium to cause the objects to separate as part of dielectrophoresis separation. Specifically, as dielectrophoretic forces applied to an object depend on whether the object has a positive or negative CM factor, and as whether the object has a positive or negative CM factor depends on a radian frequency of a non-uniform electric field applied to the object, a radian frequency or range of radian frequencies can be selected for a non-uniform electric field to cause application of a positive dielectrophoretic force to the object.

In the diagram 300, line 302 represent the CM factor of a tumor cell within a volume of blood as a function of a radian frequency of an applied non-uniform electric field. As illustrated by line 302, the CM factor for the tumor cell within the volume of blood is negative until a radian frequency 304 of an applied non-uniform electric field. At radian frequencies of applied non-uniform electric fields greater than radian frequency 304, the CM factor for the tumor cell within the volume of blood is positive. Therefore, the tumor cell within the volume of blood experiences positive dielectrophoretic forces in response to applied non-uniform electric fields with radian frequencies greater than radian frequency 304.

In the diagram 300, line 306 represent the CM factor of a white blood cell within a volume of blood as a function of a radian frequency of an applied non-uniform electric field. As illustrated by line 306, the CM factor for the white blood cell within the volume of blood is negative until a radian frequency 308 of an applied non-uniform electric field. At radian frequencies of applied non-uniform electric fields lower than radian frequency 308, the CM factor for the white blood cell within the volume of blood is negative. Therefore, the white blood cell within the volume of blood experiences negative dielectrophoretic forces in response to applied non-uniform electric fields with radian frequencies less than radian frequency 308.

As shown in diagram 300, within the radian frequency range 310 between radian frequency 304 and radian frequency 308, the CM factor for the tumor cell within the volume of blood, represented by line 304, is positive. Additionally, within the radian frequency range 310 between radian frequency 304 and radian frequency 308, the CM factor for the white blood cell within the volume of blood, represented by line 306, is negative. As a result, in response to an applied non-uniform electric field with a radian frequency that remains within the radian frequency range 310, tumor cells within the volume of blood experience a positive dielectrophoretic force while white blood cells within the volume of blood experience a negative dielectrophoretic force. This can be used to separate the tumor cells from the volume of blood through dielectrophoresis separation. For example, a non-uniform electric field applied to a volume of blood can be kept within the radian frequency range 310 to cause the tumor cells to migrate out of the volume of blood into a buffer. Further, in the example tumor cells in eight cubic centimeters of blood can be separated from the blood in an hour or less at a depletion rate of 0.003 and a capture efficiency of 0.901 through application of a non-uniform electric field to the blood with a radian frequency in the radian frequency range 310.

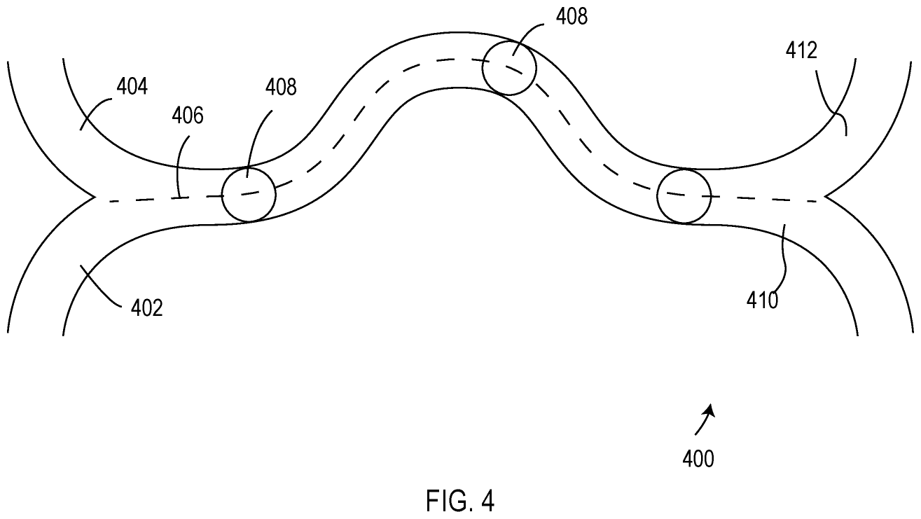

FIG. 4 depicts a diagram of a top view of an example dielectrophoresis separation channel 400 used to sort objects in a medium through dielectrophoresis separation. The dielectrophoresis separation channel 400 can be used to sort cells from a volume of blood using dielectrophoresis separation. For example, the dielectrophoresis separation channel 400 can be used to sort tumor cells from a volume of blood flowed through the dielectrophoresis separation channel 400 using dielectrophoresis separation. The dielectrophoresis separation channel 400 can be of a size on the μm scale to create a microfluidic channel. For example, the dielectrophoresis separation channel 400 can have a sidewall height of four hundred μm. Additionally, the dielectrophoresis separation channel 400 can have a depth of a varying level. In having a depth of a varying level, a flow of a contained liquid within the channel 400 can be focused, potentially leading to increased throughput of an amount of liquid processed through dielectrophoresis separation.

The dielectrophoresis separation channel 400 includes a sample inlet 402. The sample inlet 402 can be used to introduce a flow of a volume of a liquid solution containing objects to be sorted through dielectrophoresis separation. For example, the sample inlet 402 can be used to introduce a flow of a volume of blood into the dielectrophoresis separation channel 400 for purposes of sorting cells in the volume of blood. A flow of a volume of a liquid solution introduced through the sample inlet 402 can be created through an applicable mechanism for displacing a liquid. For example, a flow of a volume of a liquid solution introduced through the sample inlet can be created through a pump or as a result of capillary motion within the dielectrophoresis separation channel 400.

The dielectrophoresis separation channel 400 includes a buffer inlet 404. The buffer inlet 404 can be used to introduce a flow of a volume of a liquid buffer into the dielectrophoresis separation channel 400. For example, the buffer inlet 404 can be used to introduce a flow of a volume of water acting as a liquid buffer in sorting objects from a flow of a volume of a liquid solution through dielectrophoresis separation. A flow of a volume of a liquid buffer introduced into the dielectrophoresis separation channel 400 through the buffer inlet 404 can flow adjacent to a flow of a volume of a liquid solution. More specifically, a flow of a volume of a liquid buffer introduced into the dielectrophoresis separation channel 400 through the buffer inlet 404 can flow adjacent to a flow of a volume of a liquid solution introduced to the dielectrophoresis separation channel 400 through the sample inlet 402.

Either or both the sample inlet 402 and the buffer inlet 404 can be positioned as part of the dielectrophoresis separation channel 400 to cause a flow of a buffer introduced through the buffer inlet 404 to flow adjacent to a flow of a volume of liquid solution introduced through the sample inlet 402. For example the sample inlet 402 and the buffer inlet 404 can be positioned to cause a flow of a buffer to flow adjacent to a flow of a volume of liquid solution, e.g. roughly along line 406 within the dielectrophoresis separation channel 400. In flowing adjacent to a flow of a buffer, objects within the flow of the volume of liquid solution can be caused to segment into a flow of a buffer through dielectrophoresis separation. For example, cells within a volume of blood flowed through the dielectrophoresis separation channel 400 an migrate to a flow of a volume of buffer as a result of dielectrophoretic forces applied to the cells as a result of application of a non-uniform electric field to the flow of the volume of blood through the dielectrophoresis separation channel 400.

The electrodes 408 are positioned with respect to the dielectrophoresis separation channel 400 to cause creation of a non-uniform electric field within the channel 400. For example, the electrodes 408 can be positioned beneath the dielectrophoresis separation channel 400 to create a non-uniform electric field within the channel Additionally, the electrodes 408 can be of a size to cause creation of a non-uniform electric field within the channel 400. For example, the electrodes can be of a same size as a width of the dielectrophoresis separation channel 400, as shown in FIG. 4, to create a non-uniform electric field within the channel 400. The electrodes 408 can be supplied power based on characteristics of sorting objects in a flow of a liquid through the dielectrophoresis separation channel 400 using dielectrophoresis separation. For example, the electrodes 408 can be supplied power and subsequently generate a non-uniform electric field based on characteristics of objects to be sorted from a flow of a liquid solution through the dielectrophoresis separation channel 400 using dielectrophoresis separation.

The dielectrophoresis separation channel 400 includes a sample outlet 410. A sample outlet 410 included as part of the dielectrophoresis separation channel 400 includes an opening through which a flow of a volume of liquid solution can flow after it has been sampled through dielectrophoresis separation in the channel 400. For example, a volume of blood in which a non-uniform electric field has been applied to sort cells within the blood can flow out of the dielectrophoresis separation channel 400 through the sample outlet 410. Additionally, the dielectrophoresis separation channel includes a buffer outlet 412. A buffer outlet 412 includes an opening through which a flow of a volume of liquid buffer can flow after it has gathered objects from a sampled liquid solution through dielectrophoresis separation. For example, a buffer outlet 412 can allow a buffer to pass through it after the buffer has gathered cells within a sampled volume of blood as part of dielectrophoresis sorting. A buffer collected through a buffer outlet 412 can be used to determine a concentration of an object sorted out of a flow of a contained volume of solution through dielectrophoresis separation. For example, a buffer collected through a buffer outlet 412 can be used to determine a concentration of tumor cells in a contained volume of blood which are separated from the volume of blood through dielectrophoresis separation.

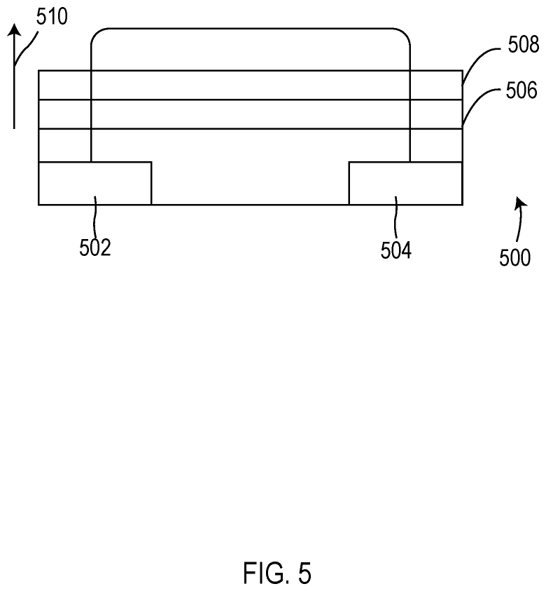

FIG. 5 depicts a cross-sectional view of an electrode configuration 500 used to produce a non-uniform electrode field for purposes of sorting objects through dielectrophoresis separation. The electrode configuration 500 shown in FIG. 5 can be included as part of an applicable device for sorting objects through dielectrophoresis separation, such as the dielectrophoresis cell sorting microfluidic devices described in this paper. Specifically, the electrode configuration 500 can be integrated to apply a non-uniform electric field to a non-linear dielectrophoresis separation channel for purposes of sorting objects in a contained volume of liquid solution in the channel. For example, the electrode configuration 500 can be used to apply a non-uniform electric field to a volume of blood contained in a non-linear dielectrophoresis separation channel for purposes of sorting cells within the volume of blood.

The electrode configuration 500 includes first and second electrodes 502 and 504. The first and second electrodes 502 and 504 are positioned with respect to a non-linear dielectrophoresis separation channel to produce a non-uniform electric field within the channel. For example, the first and second electrodes 502 and 504 can be positioned beneath a non-linear dielectrophoresis separation channel. The first and second electrodes 502 and 504 can produce a non-uniform electric field in response to power provided the electrodes 502 and 504. An amount of power provided to the electrodes 502 and 504 can be provided based on characteristics of sorting objects through dielectrophoresis separation. For example, an amount of power provided to the electrodes 502 and 504 can be managed based on characteristics of a target object to sort from an object within a contained volume of liquid solution through dielectrophoresis separation.

The electrode configuration 500 is integrated as part of a device that includes a dielectric layer 506 between the electrodes 502 and 504 and a dielectrophoresis channel layer 508. The dielectrophoresis channel layer 508 is configured to contain one or a plurality of dielectrophoresis separation channels used to sort objects in a medium through dielectrophoresis separation. A dielectrophoresis separation channel included in the dielectrophoresis channel layer 508 can be non-liner dielectrophoresis separation channel. For example, a dielectrophoresis separation channel included in the dielectrophoresis channel layer can include a serpentine shaped dielectrophoresis separation channel.

The dielectric layer 506 can be formed from an applicable dielectric material. Additionally, the dielectric layer 506 can be integrated or otherwise include carbon nanotubes to increase the conductivity of the dielectric layer 506. The dielectric layer 506 functions to focus a non-uniform electric field created by the electrodes 502 and 504 in a dielectrophoresis separation channel within the dielectrophoresis channel layer 508. The dielectric layer 506 can focus a non-uniform electric field into a dielectrophoresis separation channel in the dielectrophoresis channel layer 508 by limiting or otherwise removing the non-uniform electric field along axis 510. By limiting or otherwise removing the non-uniform electric field along axis 510, the dielectric layer 506 can limit the amount of a non-uniform electric field extending above a dielectrophoresis separation channel in the dielectrophoresis channel layer 508.

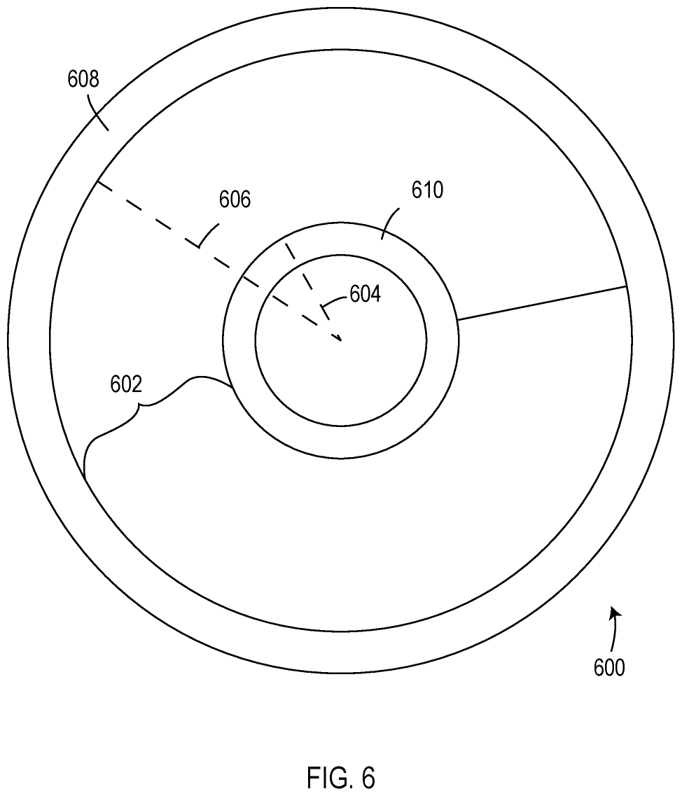

FIG. 6 depicts a diagram of a top view of a cross-section of an example circular helix shaped dielectrophoresis separation channel 600 used to sort objects in a medium through dielectrophoresis separation. The circular helix shaped dielectrophoresis separation channel 600 is circular shaped in that it can have a circular footprint. The circular helix shaped dielectrophoresis separation channel 600 can be used to sort cells from a volume of blood using dielectrophoresis separation. For example, the circular helix shaped dielectrophoresis separation channel 600 can be used to sort tumor cells from a volume of blood flowed through the circular helix shaped dielectrophoresis separation channel 600 using dielectrophoresis separation. The circular helix shaped dielectrophoresis separation channel 600 can be of a size on the μm scale to create a microfluidic channel. For example, the circular helix shaped dielectrophoresis separation channel 600 can have a sidewall height of four hundred μm. In another example, the circular helix shaped dielectrophoresis separation channel 600 can have a channel width 602 of five hundred μm. Additionally, the circular helix shaped dielectrophoresis separation channel 600 can have a depth of a varying level. In having a depth of a varying level, a flow of a contained liquid within the channel 600 can be focused, potentially leading to increased throughput of an amount of liquid solution processed using dielectrophoresis separation.

The circular helix shaped dielectrophoresis separation channel 600 includes an inner radius 604 and an outer radius 606 that define the channel width 602 at any given point within the channel 600. The inner radius 604 is the distance from a center of the helix formed by the circular helix shaped dielectrophoresis separation channel 600 to an inner wall of the channel 600. The outer radius 606 is the distance from a center of the helix formed by the circular helix shaped dielectrophoresis separation channel 600 to an outer wall of the channel 600. Either or both the inner radius 604 and the outer radius 606 can vary along a height of the circular helix shaped dielectrophoresis separation channel 600. In varying either or both the inner radius 604 and the outer radius 606 along the height of the circular helix shaped dielectrophoresis separation channel 600, the channel width 602 can be varied along the height of the channel 600. In varying the channel width 602 along the height of the circular helix shaped dielectrophoresis separation channel 600 a flow of a contained volume of liquid within the channel 600 can be focused, potentially leading to greater throughput in processing the volume of liquid using dielectrophoresis separation.

A first electrode 608 and a second electrode 610 are positioned with respect to the circular helix shaped dielectrophoresis separation channel 600 to cause creation of a non-uniform electric field in the channel 600. Specifically, the first electrode 608 is positioned along an outer wall or portions of the outer wall of the circular helix shaped dielectrophoresis separation channel 600. Additionally, the second electrode 610 is positioned is positioned along an inner wall or portions of the inner wall of the circular helix shaped dielectrophoresis separation channel 600. While the first electrode and the second electrode 608 and 610 are shown to be positioned along an outer wall and an inner wall of the circular helix shaped dielectrophoresis separation channel 600, the first electrode and the second electrode 608 and 610 can be positioned with respect to the circular helix shaped dielectrophoresis separation channel 600 at applicable positions to cause creation of a non-uniform electric field within the channel 600. The first electrode 608 can be larger than the second electrode 610 leading to creation of a non-uniform electric field within the circular helix shaped dielectrophoresis separation channel 600.

In a specific implementation, the first electrode 608 and the second electrode 610 are supplied power based on characteristics of sorting objects in a flow of a liquid through the circular helix shaped dielectrophoresis separation channel 600 using dielectrophoresis separation. For example, either or both the first and second electrodes 608 and 610 can be supplied power and subsequently generate a non-uniform electric field based on characteristics of objects to be sorted from a flow of a liquid solution through the circular helix shaped dielectrophoresis separation channel 600 using dielectrophoresis separation. In another example, either or both the first and second electrodes 608 and 610 can be supplied power and subsequently generate a non-uniform electric field based on characteristics of a liquid medium containing objects to be sorted in the circular helix shaped dielectrophoresis separation channel 600 using dielectrophoresis separation.

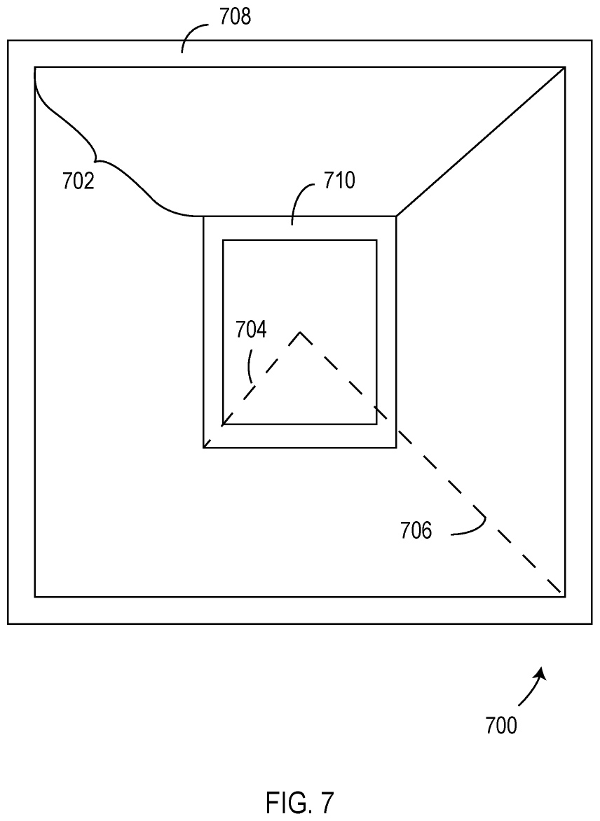

FIG. 7 depicts a diagram of a top view of a cross-section of an example square helix shaped dielectrophoresis separation channel 700 used to sort objects in a medium through dielectrophoresis separation. The square helix shaped dielectrophoresis separation channel 700 is square shaped in that it can have a square footprint. The square helix dielectrophoresis separation channel 700 can be used to sort cells from a volume of blood using dielectrophoresis separation. For example, the square helix shaped dielectrophoresis separation channel 700 can be used to sort tumor cells from a volume of blood flowed through the square helix shaped dielectrophoresis separation channel 700 using dielectrophoresis separation. The square helix shaped dielectrophoresis separation channel 700 can be of a size on the μm scale to create a microfluidic channel. For example, the square helix shaped dielectrophoresis separation channel 700 can have a sidewall height of four hundred μm. In another example, the square helix shaped dielectrophoresis separation channel 700 can have a channel width 702 of five hundred μm. Additionally, the square helix shaped dielectrophoresis separation channel 700 can have a depth of a varying level. In having a depth of a varying level, a flow of a contained liquid within the channel 700 can be focused, potentially leading to increased throughput of an amount of liquid solution processed using dielectrophoresis separation.

The square helix shaped dielectrophoresis separation channel 700 includes an inner radius 704 and an outer radius 706 that define the channel width 702. The inner radius 704 is the distance along a diagonal from a center of the helix formed by the square helix shaped dielectrophoresis separation channel 700 to an inner wall of the channel 700. The outer radius 706 is the distance along a diagonal from a center of the helix formed by the square helix shaped dielectrophoresis separation channel 700 to an outer wall of the channel 700. Either or both the inner radius 704 and the outer radius 706 can vary along a height of the square helix shaped dielectrophoresis separation channel 700. In varying either or both the inner radius 704 and the outer radius 706 along the height of the square helix shaped dielectrophoresis separation channel 700, the channel width 702 can be varied along the height of the channel 700. In varying the channel width 702 along the height of the square helix shaped dielectrophoresis separation channel 700 a flow of a contained volume of liquid within the channel 700 can be focused, potentially leading to greater throughput in processing the volume of liquid using dielectrophoresis separation.

A first electrode 708 and a second electrode 710 are positioned with respect to the square helix shaped dielectrophoresis separation channel 700 to cause creation of a non-uniform electric field in the channel 700. Specifically, the first electrode 708 is positioned along an outer wall or portions of the outer wall of the square helix shaped dielectrophoresis separation channel 700. Additionally, the second electrode 710 is positioned is positioned along an inner wall or portions of the inner wall of the square helix shaped dielectrophoresis separation channel 700. While the first electrode and the second electrode 708 and 710 are shown to be positioned along an outer wall and an inner wall of the square helix shaped dielectrophoresis separation channel 700, the first electrode and the second electrode 708 and 710 can be positioned with respect to the square helix shaped dielectrophoresis separation channel 700 at applicable positions to cause creation of a non-uniform electric field within the channel 700. The first electrode 708 can be larger than the second electrode 710 leading to creation of a non-uniform electric field within the circular helix shaped dielectrophoresis separation channel 700.

In a specific implementation, the first electrode 708 and the second electrode 710 are supplied power based on characteristics of sorting objects in a flow of a liquid through the square helix shaped dielectrophoresis separation channel 700 using dielectrophoresis separation. For example, either or both the first and second electrodes 708 and 710 can be supplied power and subsequently generate a non-uniform electric field based on characteristics of objects to be sorted from a flow of a liquid solution through the square helix shaped dielectrophoresis separation channel 700 using dielectrophoresis separation. In another example, either or both the first and second electrodes 708 and 710 can be supplied power and subsequently generate a non-uniform electric field based on characteristics of a liquid medium containing objects to be sorted in the square helix shaped dielectrophoresis separation channel 700 using dielectrophoresis separation.

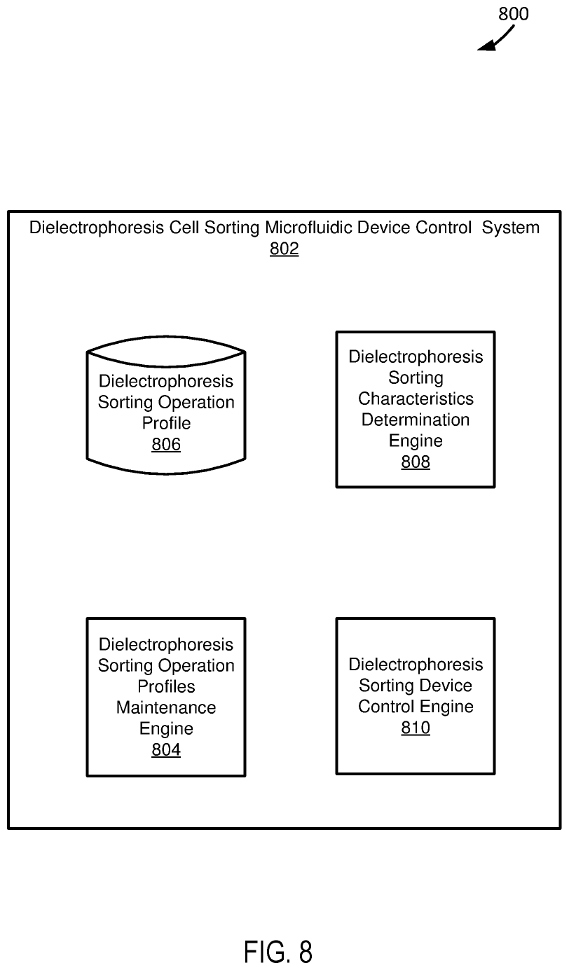

FIG. 8 depicts a diagram 800 of an example of a dielectrophoresis cell sorting microfluidic device control system 802. The dielectrophoresis cell sorting microfluidic device control system 802 is intended to represent a system that functions according to an applicable system for controlling a device for sorting objects using dielectrophoresis separation, such as the dielectrophoresis cell sorting microfluidic device control systems described in this paper. In controlling operation of a device for sorting objects using dielectrophoresis separation, the dielectrophoresis cell sorting microfluidic device control system 802 can maintain dielectrophoresis sorting operation profiles. Dielectrophoresis sorting operation profiles indicate specific operation parameters to cause a device for sorting objects to operate at in sorting objects through dielectrophoresis separation. For example, a dielectrophoresis sorting operation profile can indicate a specific amount of power to provide to specific electrodes in creating a non-uniform electric field for purposes of sorting objects using dielectrophoresis separation. Dielectrophoresis sorting operation profiles can indicate specific operation parameters associated with characteristics of sorting objects through dielectrophoresis separation. For example, if a specific blood cell is to be sorted using dielectrophoresis separation, and the specific blood cell experiences a positive dielectrophoretic force at a radian frequency of an applied non-uniform electric field within a specific frequency range, then a dielectrophoresis sorting operation profile can specify providing a specific amount of power to electrodes to cause creation of a non-uniform electric field within the specific frequency range.

In a specific implementation, the dielectrophoresis cell sorting microfluidic device control system 802 functions to determine characteristics of sorting objects through dielectrophoresis separation. For example, the dielectrophoresis cell sorting microfluidic device control system 802 can determine a specific type of cell is to be sorted from a volume of blood using dielectrophoresis separation. The dielectrophoresis cell sorting microfluidic device control system 802 can use determined characteristics of sorting objects through dielectrophoresis separation to control operation of a device configured to sort objects through dielectrophoresis separation. For example, if a specific type of object is to be sorted from a liquid solution, then the dielectrophoresis cell sorting microfluidic device control system 802 can control power provided to a device configured to sort the object using dielectrophoresis separation to cause application of a positive dielectrophoretic force to the specific type of object. Additionally, the dielectrophoresis cell sorting microfluidic device control system 802 can use a dielectrophoresis sorting operation profile to control operation of a device configured to sort objects through dielectrophoresis separation. For example, the dielectrophoresis cell sorting microfluidic device control system 802 can use a dielectrophoresis sorting operation profile associated with specific characteristics of sorting objects through dielectrophoresis separation to control operation of a device configured to sort objects based on the specific characteristics using dielectrophoresis separation.

Referring back to FIG. 8, the dielectrophoresis cell sorting microfluidic device control system 802 includes a dielectrophoresis sorting operation profiles maintenance engine 804, a dielectrophoresis sorting operation profile datastore 806, a dielectrophoresis sorting characteristics determination engine 808, and a dielectrophoresis sorting device control engine 810. The dielectrophoresis sorting operation profiles maintenance engine 804 is intended to represent an engine that functions to maintain dielectrophoresis sorting operation profiles. Dielectrophoresis sorting operation profiles maintained by the dielectrophoresis sorting operation profiles maintenance engine 804 can be used to control operation of a device configured to sort objects using dielectrophoresis separation. The dielectrophoresis sorting operation profiles maintenance engine 804 can maintain dielectrophoresis sorting operation profiles based on characteristics of sorting objects through dielectrophoresis separation. For example, the dielectrophoresis sorting operation profiles maintenance engine 804 can associate specific operation parameters of a device configured to sort objects using dielectrophoresis separation with characteristics of sorting objects through dielectrophoresis separation. For example, the dielectrophoresis sorting operation profiles maintenance engine 804 can associate a voltage to apply at electrodes in creating a non-uniform electric field for purposes of sorting a specific object using dielectrophoresis separation with an identification of the specific object.

In a specific implementation, the dielectrophoresis sorting operation profiles maintenance engine 804 functions to maintain dielectrophoresis sorting operation profiles based on input received from an applicable source. Specifically, the dielectrophoresis sorting operation profiles maintenance engine 804 can maintain dielectrophoresis sorting operation profiles based on input received from a controlling source. For example, the dielectrophoresis sorting operation profiles maintenance engine 804 can maintain dielectrophoresis sorting operation profiles based on input receive from an operator or a manufacturer of a device configured to sort objects through dielectrophoresis separation.

Referring back to FIG. 8, the dielectrophoresis sorting operation profile datastore 806 is intended to represent a datastore that functions to store data indicating dielectrophoresis sorting operation profiles. For example, data stored in the dielectrophoresis sorting operation profile datastore 806 can indicate operation parameters of a device configured to sort objects through dielectrophoresis separation and specific characteristics of sorting objects through dielectrophoresis separation. Data stored in the dielectrophoresis sorting operation profile datastore 806 can be used to control operation of a device configured to sort objects using dielectrophoresis separation. Additionally, data stored in the dielectrophoresis sorting operation profile datastore 806 can be used to control operation of a device configured to sort objects using dielectrophoresis separation based on specific characteristics of sorting objects through dielectrophoresis separation.

The dielectrophoresis sorting characteristics determination engine 808 is intended to represent an engine that functions to determine characteristics of sorting objects through dielectrophoresis separation. For example, the dielectrophoresis sorting characteristics determination engine 808 can determine that a specific type of cell is to be sorted from a volume of blood using dielectrophoresis separation. In another example, the dielectrophoresis sorting characteristics determination engine 808 can determine a specific type of object is to be sorted from a specific type of medium containing the object using dielectrophoresis separation. The dielectrophoresis sorting characteristics determination engine 808 can determine characteristics of sorting objects through dielectrophoresis separation based on input received from an applicable source. For example, the dielectrophoresis sorting characteristics determination engine 808 can determine an identity of a specific target cell to sort using dielectrophoresis separation based on input received from an operator of a device configured to sort objects using dielectrophoresis separation.

The dielectrophoresis sorting device control engine 810 is intended to represent an engine that functions to control an applicable device configured to sort objects using dielectrophoresis separation, such as the dielectrophoresis cell sorting microfluidic devices described in this paper. The dielectrophoresis sorting device control engine 810 can control a device configured to sort objects using dielectrophoresis separation based on characteristics of sorting objects through dielectrophoresis separation performed at the device. For example, the dielectrophoresis sorting device control engine 810 can control a voltage applied to electrodes of a device configured to sort objects through dielectrophoresis separation to cause the device to apply a positive dielectrophoretic force to a target object to be sorted by the device. Additionally, the dielectrophoresis sorting device control engine 810 can control a device configured to sort objects using dielectrophoresis separation based on a dielectrophoresis sorting operation profile. For example, based on operation parameters indicated by a dielectrophoresis sorting operation profile, the dielectrophoresis sorting device control engine 810 can control a device configured to sort objects through dielectrophoresis separation.

In an example of operation of the example system shown in FIG. 8, the dielectrophoresis sorting operation profiles maintenance engine 804 maintains a dielectrophoresis sorting operation profile indicating operation parameters to follow in controlling operation of a device configured to sort objects through dielectrophoresis separation. In the example of operation of the example system shown in FIG. 8, the dielectrophoresis sorting operation profiles maintenance engine 804 associates the dielectrophoresis sorting operation profile with specific characteristics of sorting objects through dielectrophoresis separation. Further, in the example of operation of the example system shown in FIG. 8, the dielectrophoresis sorting characteristics determination engine 808 determines a device configured to sort objects using dielectrophoresis separation is or will be sorting objects according to the specific characteristics of sorting objects through dielectrophoresis separation. In the example of operation of the example system shown in FIG. 8, the dielectrophoresis sorting device control engine 810 controls operation of the device configured to sort objects according to the dielectrophoresis sorting operation profile based on the determination that the device is or will be sorting objects according to the specific characteristics of sorting objects through dielectrophoresis separation.

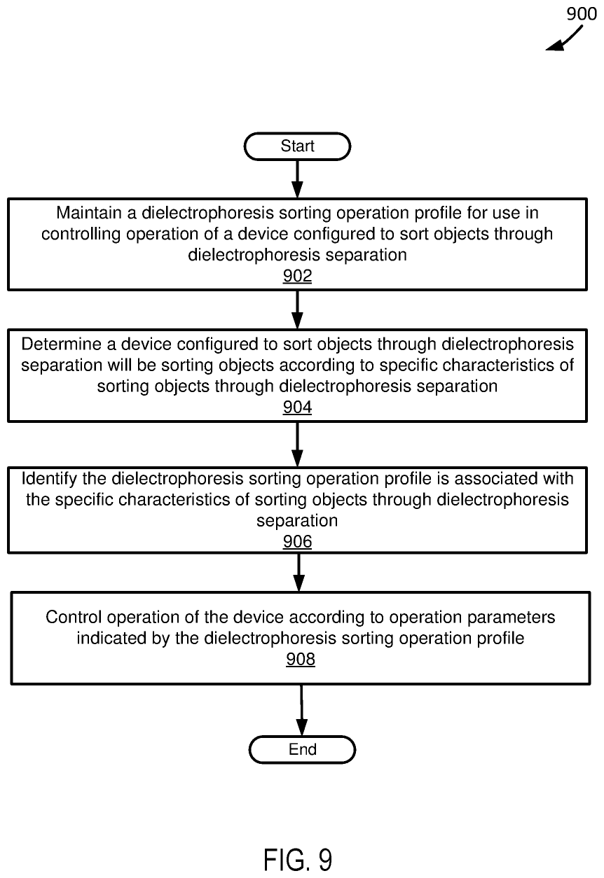

FIG. 9 depicts a flowchart 900 of an example of a method for controlling operation of a device configured to sort objects through dielectrophoresis separation based on characteristics of sorting objects through dielectrophoresis separation. The flowchart 900 begins at module 902, where a dielectrophoresis sorting operation profile is maintained for use in controlling operation of a device configured to sort objects through dielectrophoresis separation. An applicable engine for maintaining dielectrophoresis sorting operation profiles, such as the dielectrophoresis sorting operation profiles maintenance engines described in this paper, can maintain a dielectrophoresis sorting operation profile for use in controlling operation of a device configured to sort objects through dielectrophoresis separation. A dielectrophoresis sorting operation profile can include operation parameters to follow in controlling operation of a device configured to sort objects through dielectrophoresis separation. Additionally, a dielectrophoresis sorting operation profile can be associated with characteristics of sorting objects through dielectrophoresis separation.

The flowchart 900 continues to module 904, where it is determined a device configured to sort objects through dielectrophoresis separation will be sorting objects according to specific characteristics of sorting objects through dielectrophoresis separation. For example, it can be determined a device configured to sort objects through dielectrophoresis separation will actually be sorting a specific type of object, as included as part of specific characteristics of sorting objects through dielectrophoresis separation. An applicable engine for determining characteristics at which a device will sort object through dielectrophoresis, such as the dielectrophoresis sorting characteristics determination engines described in this paper, can determine a device configured to sort objects through dielectrophoresis separation will be sorting objects according to specific characteristics of sorting objects through dielectrophoresis separation.

The flowchart 900 continues to module 906, where it is identified that the dielectrophoresis sorting operation profile is associated with the specific characteristics of sorting objects through dielectrophoresis separation. For example, it can be determined that the dielectrophoresis sorting operation profile should be used when a device is sorting objects of a specific type using dielectrophoresis separation. An applicable engine for controlling operation of a device configured to sort objects through dielectrophoresis separation, such as the dielectrophoresis sorting device control engines described in this paper, can identify that the dielectrophoresis sorting operation profile is associated with the specific characteristics of sorting objects through dielectrophoresis separation.

The flowchart 900 continues to module 908, where operation of the device configured to sort objects through dielectrophoresis separation is controlled according to operation parameters indicated by the dielectrophoresis sorting operation profile. For example, power can be provided to electrodes of the device to cause application of a positive dielectrophoretic force on a specific type of objects to be sorted by the device using dielectrophoresis separation. An applicable engine for controlling operation of a device configured to sort objects through dielectrophoresis separation, such as the dielectrophoresis sorting device control engines described in this paper, can control operation of the device configured to sort objects through dielectrophoresis separation according to operation parameters indicated by the dielectrophoresis sorting operation profile.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A device comprising:
a non-linear dielectrophoresis separation channel configured to contain a flow of a volume of a liquid solution within the channel and a flow of a volume of a liquid buffer within the non-linear dielectrophoresis separation channel adjacent to the flow of the volume of the liquid solution, the volume of the liquid solution including first objects of a first specific type of object to sort from the volume of liquid solution using dielectrophoresis separation;
a sample inlet configured to introduce the flow of the volume of the liquid solution into the non-linear dielectrophoresis separation channel;
a buffer inlet configured to introduce the flow of the volume of the liquid buffer into the non-linear dielectrophoresis separation channel;
a plurality of electrodes positioned with respect to the non-linear dielectrophoresis separation channel and configured to apply a non-uniform electric field to the flow of the volume of the liquid solution contained within the non-linear dielectrophoresis separation channel based on characteristics of sorting objects through dielectrophoresis separation including characteristics of the first objects of the first specific type of object to sort from the volume of liquid solution, the non-uniform electric field causing the first objects of the first specific type of object to migrate from the flow of the volume of the liquid solution into the flow of the volume of liquid buffer within the non-linear dielectrophoresis separation channel through dielectrophoresis separation.

2. The device of claim 1, wherein the non-linear dielectrophoresis separation channel is configured to process a flow of eight cubic centimeters of the liquid solution within an hour or less using dielectrophoresis separation.

3. The device of claim 1, wherein the characteristics of sorting objects through dielectrophoresis includes characteristics of second objects of a second specific type of object within the volume of the liquid solution to separate from the first objects of the first specific type of object.

4. The device of claim 1, wherein the plurality of electrodes are positioned beneath portions of the non-linear dielectrophoresis separation channel.

5. The device of claim 1, further comprising:
a dielectrophoresis sorting device control engine configured to provide power to the plurality of electrodes based on the characteristics of sorting through dielectrophoresis separation including the characteristics of the first objects of the first specific type of object;
the plurality of electrodes configured to generate the non-uniform electric field using the power provided based on the characteristics of sorting through dielectrophoresis separation including the characteristics of the first objects of the first specific type of object.

6. The device of claim 1, wherein the plurality of electrodes are configured to generate the non-uniform electric field within the non-linear dielectrophoresis separation channel at a specific radian frequency or a specific range of radian frequencies based on the characteristics of sorting through dielectrophoresis separation including the characteristics of the first objects of the first specific type of object.

7. The device of claim 1, wherein the non-linear dielectrophoresis separation channel is a serpentine shaped channel.

8. The device of claim 1, wherein the non-linear dielectrophoresis separation channel is a microfluidic channel.

9. The device of claim 1, wherein the non-linear dielectrophoresis separation channel has a channel height on the micrometer scale.

10. The device of claim 1, wherein the non-linear dielectrophoresis separation channel is a circular helix shaped dielectrophoresis separation channel including an inner radius and an outer radius that define a channel width of the non-linear dielectrophoresis separation channel.

11. The device of claim 1, wherein the non-linear dielectrophoresis separation channel is a circular helix shaped dielectrophoresis separation channel including an inner radius and an outer radius that varies to define a varying channel width of the non-linear dielectrophoresis separation channel.

12. The device of claim 1, wherein the non-linear dielectrophoresis separation channel is a square helix shaped dielectrophoresis separation channel including an inner radius and an outer radius that define a channel width of the non-linear dielectrophoresis separation channel.

13. The device of claim 1, wherein the non-linear dielectrophoresis separation channel is a square helix shaped dielectrophoresis separation channel including an inner radius and an outer radius that varies to define a varying channel width of the non-linear dielectrophoresis separation channel.

14. The device of claim 1, wherein the non-linear dielectrophoresis separation channel has a varying depth to cause focusing of either or both the flow of the volume of the liquid solution and the flow of the volume of liquid buffer within the non-linear dielectrophoresis separation channel.

15. The device of claim 1, wherein the non-linear dielectrophoresis separation channel is fabricated from a sterilizable material to allow the non-linear dielectrophoresis separation channel to be sterilized for repeated uses.

16. The device of claim 1, further comprising a dielectric layer disposed between the plurality of electrodes and the non-linear dielectrophoresis separation channel, the dielectric layer configured to limit the non-uniform electric field from extending out of the non-linear dielectrophoresis separation channel.

17. The device of claim 1, further comprising a dielectric layer disposed between the plurality of electrodes and the non-linear dielectrophoresis separation channel, the dielectric layer configured to limit the non-uniform electric field from extending out of the non-linear dielectrophoresis separation channel and including carbon nanotubes to increase the conductivity of the dielectric layer.

18. The device of claim 1, wherein the first objects of the first specific type of object are sorted using dielectrophoresis separation at a depletion rate of 0.003 or less.

19. The device of claim 1, wherein the first objects of the first specific type of object are sorted using dielectrophoresis separation at a capture efficiency of 0.901 or greater.

20. The device of claim 1, wherein the volume of the liquid solution includes blood and the first objects of the first specific type of object include tumor cells within the blood.

21. A method comprising:
maintaining a dielectrophoresis sorting operation profile for use in controlling operation of dielectrophoresis cell sorting microfluidic devices configured to sort cells through dielectrophoresis separation;
determining a dielectrophoresis cell sorting microfluidic device is operating to sort specific cells according to specific characteristics of sorting cells through dielectrophoresis separation including characteristics of the specific cells;
identifying that the dielectrophoresis sorting operation profile is associated with the specific characteristics of sorting cells through dielectrophoresis separation;
controlling operation of the dielectrophoresis cell sorting microfluidic device in operating to sort the specific cells through dielectrophoresis separation according operation parameters indicated by the dielectrophoresis sorting operation profile.
